(19) United States
(12) Patent Application Publication
(10) Pub. No.: US 2021/0170832 A1
(43) Pub. Date: Jun. 10, 2021

(54) VEHICLE, INFORMATION PROCESSING APPARATUS, AND INFORMATION PROCESSING METHOD

(71) Applicant: Toyota Jidosha Kabushiki Kaisha, Toyota-shi Aichi-ken (JP)

(72) Inventors: Shunsuke Tanimori, Nagoya-shi (JP); Ryota Nakabayashi, Toyota-shi (JP); Osamu Izumida, Nagoya-shi (JP); Takeshi Kanou, Seto-shi (JP); Naoki Yamada, Toyota-shi (JP); Kazuyuki Inoue, Nagoya-shi (JP); Shin Sakurada, Toyota-shi (JP); Hiromitsu Fujii, Kariya-shi (JP)

(73) Assignee: Toyota Jidosha Kabushiki Kaisha, Toyota-shi Aichi-ken (JP)

(21) Appl. No.: 17/030,492

(22) Filed: Sep. 24, 2020

(30) Foreign Application Priority Data
Dec. 6, 2019 (JP) 2019-221305

(51) Int. Cl. B60H 3/06; G07C 5/08; B01D 53/04

(52) U.S. Cl. CPC B60H 3/0616; G07C 5/0816; B01D 53/0454; B01D 2259/4566; B60H 2003/0683; B01D 2257/90; B60H 2003/0691

(57) ABSTRACT

A vehicle includes a vehicle cabin, a filter configured to allow air blown toward the vehicle cabin to pass through the filter while adsorbing at least a portion of a substance contained in the air, a sensor configured to detect the state of the air passing through the filter, and a control device configured to output information relating to maintenance of the filter based on the result of detection performed by the sensor.

### CROSS-REFERENCE TO RELATED APPLICATION

This application claims priority to Japanese Patent Application No. 2019-221305 filed on Dec. 6, 2019, which is hereby incorporated by reference including the specification, drawings and abstract.

### BACKGROUND

### 1. Technical Field

The disclosure relates to a vehicle, an information processing apparatus, and an information processing method.

### 2. Description of Related Art

In the related art, there is known a device that decides whether to switch the mode of an air conditioning device of a vehicle from an outside air introduction mode to an inside air circulation mode based on a smell map and vehicle position information (for example, refer to Japanese Unexamined Patent Application Publication No. 2005-206110 (JP 2005-206110 A)).

### SUMMARY

A smell in a vehicle cabin influences the comfortableness of the vehicle cabin. It is desired to reduce a smell in the vehicle cabin in order to improve the comfortableness of the vehicle cabin.

The disclosure provides a vehicle, an information processing apparatus, and an information processing method with which it is possible to promote reduction of a smell in a vehicle cabin.

A first aspect of the disclosure relates to a vehicle including a vehicle cabin, a filter, a sensor, and a control device. The filter is configured to allow air blown toward the vehicle cabin to pass through the filter while adsorbing at least a portion of a substance contained in the air. The sensor is configured to detect the state of the air passing through the filter. The control device is configured to output information relating to maintenance of the filter based on the result of detection performed by the sensor.

A second aspect of the disclosure relates to an information processing apparatus including a controller. The controller is communicably connected to a vehicle including a vehicle cabin. The controller outputs information relating to the state of the vehicle based on the result of detection about the state of air passing through a filter, the filter adsorbing at least a portion of a substance contained in air blown toward the vehicle cabin.

A third aspect of the disclosure relates to an information processing method including outputting information relating to the state of a vehicle based on the result of detection about the state of air passing through a filter by a controller communicably connected to the vehicle including a vehicle cabin, the filter adsorbing at least a portion of a substance contained in air blown toward the vehicle cabin.

With the vehicle, the information processing apparatus, and the information processing method according to the aspects of the disclosure, it is possible to promote reduction of a smell in a vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration example of an information processing system according to an embodiment;

FIG. 2 is a schematic diagram showing a configuration example of an air conditioning device;

FIG. 3 is a flowchart showing an example of a procedure of an information processing method according to the embodiment;

FIG. 4 is a flowchart showing an example of a procedure of processing the result of detection performed by a sensor;

FIG. 5 is a flowchart showing an example of a procedure for determination on the necessity of maintenance of a filter that is made through analysis of the state of a vehicle;

and

FIG. 6 is a flowchart showing an example of a procedure for calculation of the evaluated value of the vehicle that is made through analysis of the state of the vehicle.

### DETAILED DESCRIPTION OF EMBODIMENTS

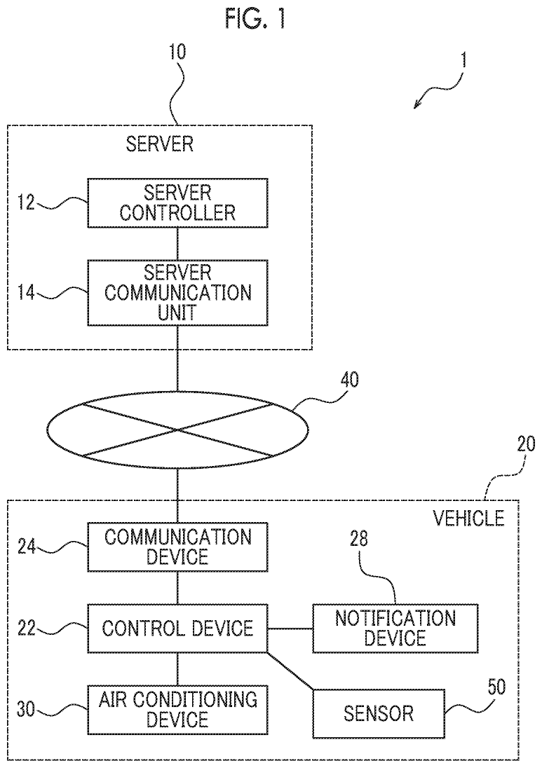

Occupants including the driver a vehicle 20 (refer to FIG. 1) or a passenger may feel unpleasant sensing a smell in the vehicle 20. Reduction of a smell in the vehicle 20 results in an improvement in comfortableness for an occupant and an improvement in value of the vehicle 20. A smell in the vehicle 20 can be reduced by means of maintenance of the vehicle 20. Providing information relating to a smell in the vehicle 20 may cause or motivate the owner of the vehicle 20 to perform maintenance of the vehicle 20.

Configuration Example of Information Processing System 1

As shown in FIG. 1, an information processing system 1 according to an embodiment includes a server 10 and the vehicle 20. The server 10 and the vehicle 20 are connected to each other via a network 40 such that the server 10 and the vehicle 20 can communicate with each other. The number of servers 10 and the number of vehicles 20 are not limited to one and may be two or more. The server 10 may also be referred to as an information processing apparatus. The server 10 may include one server apparatus or a plurality of server apparatuses that can communicate with each other.

Configuration Example of Server 10

The server 10 includes a server controller 12 and a server communication unit 14. The server controller 12 may also be simply referred to as a controller. The server controller 12 may include one or more processors. The “processors” in the present embodiment are general-purpose processors, dedicated processors dedicated to a specific process, or the like. However, the processors are not limited thereto. The server controller 12 may include one or more dedicated circuits. The dedicated circuits may include, for example, a field-programmable gate array (FPGA) or an application specific integrated circuit (ASIC). The server controller 12 may include the dedicated circuit instead of the processor and may include the dedicated circuit in addition to the processor. The server communication unit 14 may include a communication module and may communicate with the vehicle 20 via the network 40. The server 10 may further include a storage unit. The storage unit is a semiconductor memory, a magnetic memory, an optical memory, or the like. However, the storage unit is not limited thereto. The storage unit may function as a main storage device, an auxiliary storage device, or a cache memory, for example. The storage unit may include an electromagnetic storage medium such as a magnetic disk. The storage unit stores any information used to operate the server 10. For example, the storage unit may store a system program, an application program, or the like.

Configuration Example of Vehicle 20

The vehicle 20 includes a control device 22, a communication device 24, and a notification device 28. The control device 22, the communication device 24, and the notification device 28 are connected to each other such that the control device 22, the communication device 24, and the notification device 28 can communicate with each other via a vehicle-mounted network such as a controller area network (CAN) or a dedicated line.

The control device 22 controls each component included in the vehicle 20. The control device 22 may include one or more processors. The control device 22 may include one or more dedicated circuits instead of the processor and may include one or more dedicated circuits in addition to the processor. The control device 22 may further include a storage unit.

The communication device 24 is connected to the server 10 such that the communication device 24 can communicate with the server 10 via the network 40. The communication device 24 may be, for example, a vehicle-mounted communication device. The communication device 24 may include a communication module connected to the network 40. The communication module may include a communication module conforming to mobile communication standards such as the 4th Generation (4G) and the 5th Generation (5G) and is not limited thereto.

The notification device 28 notifies the driver of the vehicle 20 of information. The notification device 28 may notify the driver of the information in the form of visual information such as an image, a text, or a figure. In this case, the notification device 28 may be composed of using a display device. The display device may include a light emitting device such as a light emission diode (LED). The display device may be a liquid crystal display (LCD), for example. The display device may be an organic electro-luminescence (EL) display or an inorganic EL display. The display device may be a plasma display panel (PDP). The display device is not limited to the displays described above and other various types of displays may also be adopted.

The notification device 28 may notify the driver of the information in the form of auditory information such as a voice. In this case, the notification device 28 may be composed of a device that outputs a sound like a speaker. The notification device 28 is not limited to examples as above and may be composed of other various types of devices.

The vehicle 20 may further include a position information acquisition device, which is not essential. The position information acquisition device may be connected to the control device 22 or the communication device 24 such that the position information acquisition device and the control device 22 or the communication device 24 can communicate with each other via a vehicle-mounted network such as a controller area network (CAN) or a dedicated line. The position information acquisition device acquires position information of the vehicle 20. The position information acquisition device may include a receiver compatible with a satellite positioning system. The receiver compatible with the satellite positioning system may include, for example, a global positioning system (GPS) receiver. The vehicle 20 can acquire position information of the vehicle 20 itself by using the position information acquisition device. The vehicle 20 may output the position information of the vehicle 20 itself to the server 10.

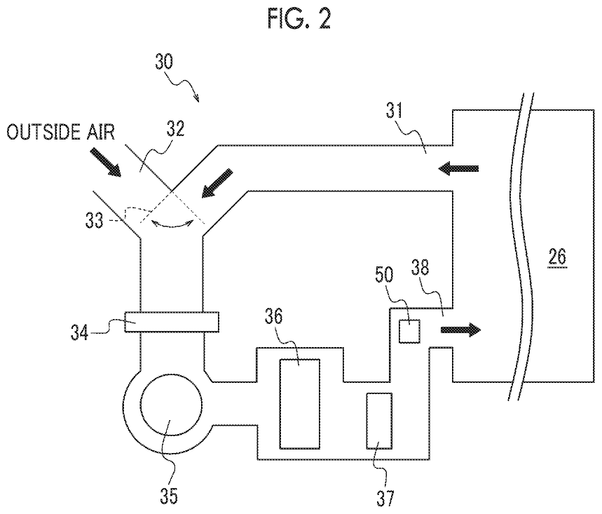

The vehicle 20 further includes an air conditioning device 30. The air conditioning device 30 may be configured to circulate air in a vehicle cabin 26 (refer to FIG. 2) of the vehicle 20 by sucking in and blowing the air in the vehicle cabin 26. The air conditioning device 30 may be configured to introduce air from the outside of the vehicle cabin 26 by sucking in air on the outside of the vehicle cabin 26 and blowing the air to the inside of the vehicle cabin 26. The air conditioning device 30 may be configured to blow, to the vehicle cabin 26, air sucked in from the outside or the inside of the vehicle cabin 26 after controlling the temperature or humidity of the air such that the temperature or humidity reaches a target value. Air that the air conditioning device 30 blows toward the vehicle cabin 26 will be also referred to as blown air.

As shown in FIG. 2, the air conditioning device 30 includes an inside air suction path 31 through which air is sucked in from the vehicle cabin 26 and an air blowing path 38 through which air is blown toward the vehicle cabin 26. The air conditioning device 30 includes a blower fan 35 between the inside air suction path 31 and the air blowing path 38. The blower fan 35 sucks in air from the inside air suction path 31 side and sends the air toward the air blowing path 38.

The air conditioning device 30 includes a filter 34. The filter 34 adsorbs at least a portion of a substance contained in air passing through the filter 34. The substance contained in the air passing through the filter 34 may contain gas or fine particles. The filter 34 may be, for example, a non-woven fabric sheet containing activated carbon particles. The activated carbon particles may adsorb the gas contained in the air passing through the filter 34. Non-woven fabric may capture the fine particles contained in the air passing through the filter 34.

The filter 34 is positioned on a side where the blower fan 35 sucks in air. The blower fan 35 sucks in air passing through the filter 34 and sends the air toward the air blowing path 38. In other words, the blower fan 35 sends air filtered by the filter 34 toward the air blowing path 38.

The filter 34 releases a substance adsorbed by the filter 34 in some cases. The more substance the filter 34 adsorbs, the greater the amount of substance released from the filter 34 may be. In a case where the amount of substance released from the filter 34 is greater than a predetermined amount, it can be said that the filter 34 has deteriorated and thus is in a state where the filter 34 needs to be subject to maintenance. The predetermined amount may correspond to the same amount as the amount of substance released in a case where substance adsorption and substance release at the filter 34 are in equilibrium. The predetermined amount may correspond to an amount obtained by multiplying, by a predetermined percentage, the amount of substance released in a case where substance adsorption and substance release at the filter 34 are in equilibrium. The predetermined percentage may be, 80% or the like. However, the predetermined fraction is not limited thereto and may be various values.

The air conditioning device 30 may include an evaporator 36 and a heater 37. The evaporator 36 and the heater 37 are positioned between the blower fan 35 and the air blowing path 38. Air that the blower fan 35 sends toward the air blowing path 38 passes through the evaporator 36 and the heater 37. The evaporator 36 cools air passing through the evaporator 36. The air cooled by the evaporator 36 causes dew condensation in some cases. Water generated due to the dew condensation is discharged by the evaporator 36. The heater 37 heats air passing through the heater 37. The air conditioning device 30 can control the temperature and humidity of air that is to be blown to the vehicle cabin 26 through the air blowing path 38, by controlling the evaporator 36 and the heater 37.

The air conditioning device 30 may include an outside air suction path 32 that joins the inside air suction path 31 in front of the filter 34. The outside air suction path 32 is configured such that air can be sucked in from the outside of the vehicle cabin 26. The air conditioning device 30 may include a flap 33 at a position where the outside air suction path 32 joins the inside air suction path 31. The flap 33 can transition into any of a state of closing the inside air suction path 31 and a state of closing the outside air suction path 32. The air conditioning device 30 causes the blower fan 35 to suck in air from the outside of the vehicle cabin 26, that is, outside air, with the flap 33 transitioning into the state of closing the inside air suction path 31. In this case, the air conditioning device 30 is operated in an outside air introduction mode. The air conditioning device 30 causes the blower fan 35 to suck in air from the inside of the vehicle cabin 26, that is, inside air, with the flap 33 transitioning into the state of closing the outside air suction path 32. In this case, the air conditioning device 30 is operated in an inside air circulation mode. That is, the air conditioning device 30 is configured to be able to switch between the outside air introduction mode and the inside air circulation mode by controlling the state of the flap 33.

The air conditioning device 30 is connected to the control device 22 such that the air conditioning device 30 and the control device 22 can communicate with each other via a vehicle-mounted network such as a controller area network (CAN) or a dedicated line. The control device 22 can control the state of blown air by controlling the air conditioning device 30. The control device 22 may change the amount of air blown from the air conditioning device 30 to the vehicle cabin 26, that is, an air volume. The control device 22 may set a control target for the state of blown air blown by the air conditioning device 30. The control target may include a target value of the temperature or humidity of the blown air, for example.

Air in the vehicle cabin 26 or blown air may contain fine particles or gas contained in cigarette smoke generated due to smoking in the vehicle cabin 26, for example. Air in the vehicle cabin 26 or blown air may contain gas released from the body of an occupant of the vehicle cabin 26, for example. The occupant may sense a smell when the occupant breathes in gas contained in air in the vehicle cabin 26 or blown air or breathes in fine particles adsorbed by the gas. Gas that a person can sense as a smell may contain a molecule having an ammonia group, an aromatic molecule, or the like. Gas or fine particles that a person can sense as a smell, that is, gas or fine particles that cause a person to sense a smell will also be referred to as a smell causing substance.

Since the filter 34 adsorbs at least a portion of fine particles or gas contained in air passing through the filter 34, the concentration of fine particles or gas contained in blown air can be reduced. Since the concentration of the fine particles or the gas contained in the blown air is reduced, the concentration of fine particles or gas contained in air in the vehicle cabin 26 may be reduced. Fine particles or gas adsorbed by the filter 34 may be released from the filter 34 at a predetermined percentage. For example, the fine particles may be separated and released from a non-woven fabric fiber. The gas may be released from activated carbon by being vaporized or volatilized. The higher the temperature of air passing through the filter 34 is, the more easily the gas adsorbed by the activated carbon is vaporized or volatilized.

In other words, a smell causing substance such as fine particles or gas is adsorbed by the filter 34. The smell causing substance may also be adsorbed by an interior furnishing such as a seat or a cover positioned in the vehicle cabin 26. The smell causing substance may also be adsorbed by a fiber included in the interior furnishing.

The vehicle 20 further includes a sensor 50. The sensor 50 is positioned at the air blowing path 38. Since the sensor 50 is positioned at the air blowing path 38, the sensor 50 can detect the state of blown air blown from the air conditioning device 30 to the vehicle cabin 26. The sensor 50 may measure the temperature or humidity of air as the state of the blown air. The sensor 50 may detect a substance contained in air as the state of the blown air. The sensor 50 may measure the concentration of a substance contained in air as the state of the blown air. The sensor 50 may measure the concentration of fine particles or gas contained in the blown air as the state of the blown air.

The sensor 50 is connected to the control device 22 such that the sensor 50 and the control device 22 can communicate with each other via a vehicle-mounted network such as a controller area network (CAN) or a dedicated line. The sensor 50 outputs the result of detection to the control device 22. The control device 22 acquires the result of detection about the state of blown air that is performed by the sensor 50. The control device 22 may output the result of detection performed by the sensor 50 to the server 10. The server controller 12 of the server 10 may acquire, from the control device 22, the result of detection about the state of blown air performed by the sensor 50.

Operation Example of Information Processing Apparatus

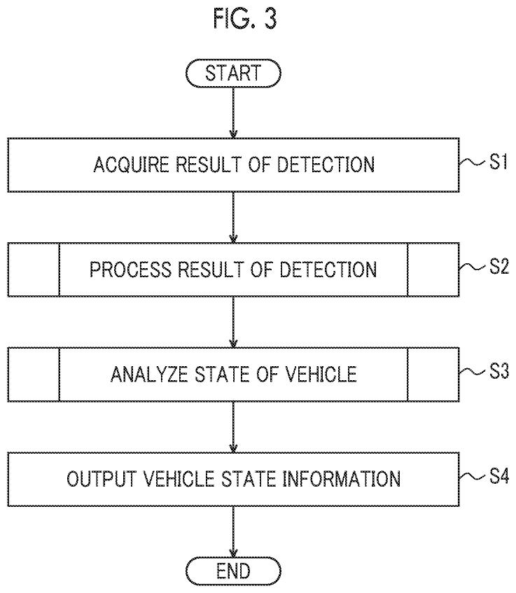

The server controller 12 of the server 10 (information processing apparatus) may perform an information processing method including a procedure as in a flowchart shown in FIG. 3, for example. The information processing method may be realized as an information processing program executed by a processor of the server controller 12 or the like. The information processing program may be stored in a non-transitory computer-readable storage medium. The processor of the server controller 12 or the like may read and execute the information processing program stored in the non-transitory computer-readable storage medium.

The server controller 12 acquires the result of detection performed by the sensor 50 from the vehicle 20 (step S1). Specifically, the server controller 12 may acquire the concentration of fine particles contained in blown air or the concentration of a smell causing substance contained in the blown air. The server controller 12 may acquire the temperature or humidity of the blown air.

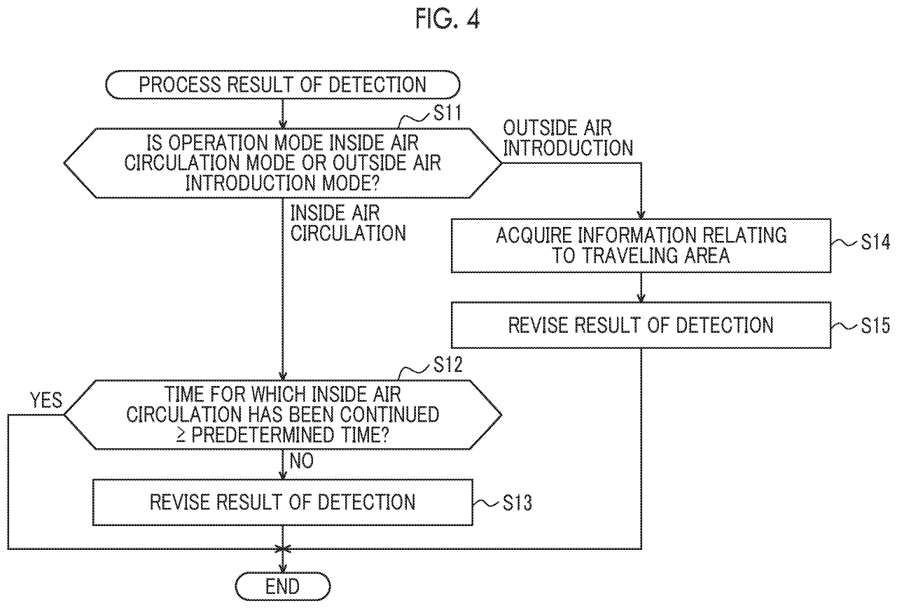

The server controller 12 processes the result of the detection performed by the sensor 50 (step S2). Specifically, the server controller 12 may perform a procedure as in a flowchart shown in FIG. 4 in a procedure in step S2.

The server controller 12 determines whether the operation mode of the air conditioning device 30 is the inside air circulation mode or the outside air introduction mode (step S11 in FIG. 4). The server controller 12 may acquire information relating to the operation mode of the air conditioning device 30 from the control device 22 of the vehicle 20 for the determination.

In a case where the operation mode of the air conditioning device 30 is the inside air circulation mode, the server controller 12 proceeds to a procedure in step S12. In a case where the operation mode of the air conditioning device 30 is the outside air introduction mode, the server controller 12 proceeds to a procedure in step S14.

In a case where the operation mode of the air conditioning device 30 is the inside air circulation mode (step S11: inside air circulation), the server controller 12 determines whether a time for which the air conditioning device 30 has continued inside air circulation is equal to or longer than a predetermined time (step S12). In a case where the time for which the inside air circulation has been continued is equal to or longer than the predetermined time (step S12: YES), the server controller 12 terminates the procedure as in the flowchart shown in FIG. 4 and returns to a procedure in step S3 in the flowchart shown in FIG. 3. That is, the server controller 12 may not perform processing with respect to the result of the detection performed by the sensor 50 in a case where the operation mode of the air conditioning device 30 is the inside air circulation mode over a time equal to or longer than the predetermined time.

In a case where the time for which the inside air circulation has been continued is shorter than the predetermined time, that is, in a case where the time for which the inside air circulation has been continued is not equal to or longer than the predetermined time (step S12: NO), the server controller 12 revises the result of the detection performed by the sensor 50 (step S13). The filter 34 cannot immediately adsorb all of fine particles or smell causing substances contained in air inside the vehicle cabin 26 after the air conditioning device 30 starts to be operated in the inside air circulation mode. The concentration of a substance contained in blown air may be gradually decreased as a time for which the air conditioning device 30 is operated in the inside air circulation mode becomes longer and the concentration may converge on a predetermined concentration. In a case where the concentration of a substance is acquired as the result of detection performed by the sensor 50, the server controller 12 may revise the result of the detection performed by the sensor 50 by estimating a predetermined concentration on which the concentration of the substance converges. After the procedure in step S13, the server controller 12 terminates the procedure as in the flowchart shown in FIG. 4 and returns to the procedure in step S3 in the flowchart shown in FIG. 3.

In a case where the operation mode of the air conditioning device 30 is the outside air introduction mode (step S11: outside air introduction), the server controller 12 acquires information relating to a traveling area of the vehicle 20 (step S14). The traveling area of the vehicle 20 corresponds to a predetermined area including the current position of the vehicle 20. Specifically, the server controller 12 may acquire the state of air in the predetermined area as the information relating to the traveling area of the vehicle 20. The state of the air in the predetermined area may include the concentration of gas or fine particles contained in smoke generated due to open burning or fire, for example. The state of the air in the predetermined area may include the concentration of gas or fine particles contained in scattering substances such as yellow sand or pollen, for example. The state of the air in the predetermined area may include, for example, the concentration of a smell causing substance containing gas or fine particles flowing out from various facilities including an industrial facility such as a factory, an agricultural facility such as a farm, and a livestock production facility such as a cowshed, a chicken house, and a piggery.

The server controller 12 revises the result of the detection performed by the sensor 50 (step S15). Specifically, in a case where the concentration of a smell causing substance such as fine particles or gas contained in blown air is acquired as the result of detection performed by the sensor 50, the server controller 12 may subtract the concentration of the smell causing substance such as the fine particles or the gas contained in air in the predetermined area from the measured value of the concentration of the smell causing substance such as the fine particles or the gas contained in the blown air. That is, the server controller 12 may regard the state of the air in the predetermined area as background data for the result of the detection performed by the sensor 50 and offset the result of the detection performed by the sensor 50. The server controller 12 may subtract a concentration, which is obtained by multiplying the concentration of the smell causing substance such as the fine particles or the gas contained in the air in the predetermined area by a predetermined coefficient, from the measured value of the concentration of the smell causing substance such as the fine particles or the gas contained in the blown air. That is, the server controller 12 may regard a value obtained by converting a value indicating the state of the air in the predetermined area with the predetermined coefficient as background data for the result of the detection performed by the sensor 50 and offset the result of the detection performed by the sensor 50. The predetermined coefficient may be set based on the specifications of the filter 34. After the procedure in step S15, the server controller 12 terminates the procedure as in the flowchart shown in FIG. 4 and returns to the procedure in step S3 in the flowchart shown in FIG. 3.

The above-described procedure in each step in the flowchart shown in FIG. 4 may be appropriately omitted and may be performed in a different order.

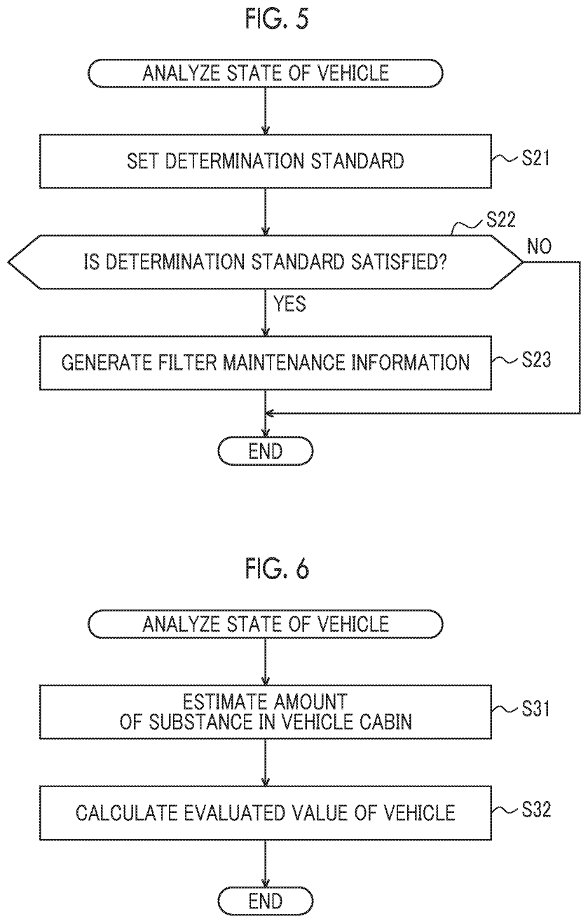

Referring again to FIG. 3, the server controller 12 analyzes the state of the vehicle 20 (step S3). Specifically, the server controller 12 may perform a procedure as in a flowchart shown in FIG. 5 or FIG. 6 in the procedure in step S3.

Hereinafter, an example where the server controller 12 performs the procedure shown in FIG. 5 as the procedure in step S3 in FIG. 3 will be described. Referring to FIG. 5, the server controller 12 sets a standard for determination on the state of the filter 34 based on the result of the detection performed by the sensor 50 (step S21). The standard for the determination on the state of the filter 34 may also be referred to as a filter determination standard. The filter determination standard is used by the server controller 12 to determine whether the filter 34 has been deteriorated and is in a state where the filter 34 needs to be subject to maintenance. Specifically, the server controller 12 may set, as the filter determination standard, a concentration threshold value that is to be compared with the concentration of the smell causing substance such as the fine particles or the gas contained in the blown air. The concentration threshold value may be set to a concentration at which the smell causing substance such as the fine particles or the gas contained in the blown air causes a predetermined influence on a person in the vehicle cabin 26. Examples of a state where the smell causing substance causes the predetermined influence may include a state where more than a predetermined percentage of persons entering the vehicle cabin 26 sense a smell. The predetermined percentage may be set to 50% or the like. However, the predetermined fraction is not limited thereto and may be set to various values.

The server controller 12 may set the filter determination standard based on the temperature of the blown air. Specifically, the higher the temperature of the blown air is, the higher the concentration threshold value may be set. This is because there is a substance that becomes more likely to be released from the filter 34 as the temperature of the blown air becomes higher. In addition, the higher the temperature of the blown air is, the higher the room temperature of the vehicle cabin 26 may be. This is because the higher the room temperature of the vehicle cabin 26 is, the more a part of a substance adsorbed by an interior furnishing in the vehicle cabin 26 becomes likely to be released from the interior furnishing.

The server controller 12 may set the concentration threshold value based on whether the operation mode of the air conditioning device 30 is the outside air introduction mode or the inside air circulation mode. The server controller 12 may set the concentration threshold value based on a time for which the inside air circulation has been continued in a case where the air conditioning device 30 has continued the inside air circulation for a time shorter than the predetermined time.

The server controller 12 determines whether or not the result of the detection performed by the sensor 50 satisfies the filter determination standard (step S22). Specifically, the server controller 12 may determine whether or not the concentration of a substance contained in the blown air is equal to or greater than the concentration threshold value. In a case where the concentration of the substance contained in the blown air is equal to or greater than the concentration threshold value, the server controller 12 may determine that the filter determination standard is satisfied. In a case where the concentration of the substance contained in the blown air is smaller than the concentration threshold value, the server controller 12 may determine that the filter determination standard is not satisfied.

In a case where the filter determination standard is not satisfied (step S22: NO), the server controller 12 terminates the procedure as in the flowchart shown in FIG. 5 and returns to a procedure in step S4 in the flowchart shown in FIG. 3. In a case where the filter determination standard is satisfied (step S22: YES), the server controller 12 determines that the filter 34 is in a state where the filter 34 needs to be subject to maintenance and generates information relating to maintenance of the filter 34 (step S23). The information relating to maintenance of the filter 34 may also be referred to as maintenance information. The maintenance information may include content promoting replacement of the filter 34. The maintenance information may include content promoting cleaning of the filter 34 with an agent or gas having a deodorizing effect or an antibacterial effect. The maintenance information may include information specifying a recommended time for replacement or cleaning of the filter 34. After the procedure in step S23, the server controller 12 terminates the procedure as in the flowchart shown in FIG. 5 and returns to the procedure in step S4 in the flowchart shown in FIG. 3.

The above-described procedure in each step in the flowchart shown in FIG. 5 may be appropriately omitted and may be performed in a different order.

Hereinafter, an example where the server controller 12 performs the procedure shown in FIG. 6 as the procedure in step S3 in FIG. 3 will be described. Referring to FIG. 6, the server controller 12 estimates the amount of substance in the vehicle cabin 26 based on the result of the detection performed by the sensor 50 (step S31). The substance in the vehicle cabin 26 may include a substance in air in the vehicle cabin 26. The substance in the vehicle cabin 26 may include a substance that is adsorbed by an interior furnishing such as a seat or a cover in the vehicle cabin 26 and may be released into air. The substance in air in the vehicle cabin 26 or the substance that may be released into air may include a smell causing substance. Specifically, the server controller 12 may estimate the amount of substance in the vehicle cabin 26 based on the concentration of the substance contained in the blown air as the result of the detection performed by the sensor 50. The server controller 12 may calculate a value obtained by multiplying the concentration of a predetermined substance contained in blown air by a predetermined coefficient as an estimated value of the amount of predetermined substance that may be released into air in the vehicle cabin 26. The predetermined coefficient may be set based on the specifications of the filter 34. The server controller 12 may estimate the range of values that the concentration of the smell causing substance in the vehicle cabin 26 may reach.

The server controller 12 calculates the evaluated value of the vehicle 20 (step S32). The evaluated value of the vehicle 20 may include an appraisal price at the time of sale or trade-in of the vehicle 20. The appraisal price of the vehicle 20 is determined based on various parameters such as the year of the vehicle 20. The evaluated value of the vehicle 20 may be used as one of parameters used to determine the appraisal price. The server controller 12 may calculate the evaluated value of the vehicle 20 as a coefficient by which the appraisal price of the vehicle 20 determined based on other parameters is to be multiplied. It will be assumed that the higher the evaluated value of the vehicle 20 is, the higher the appraisal price of the vehicle 20 is.

The server controller 12 may calculate the evaluated value of the vehicle 20 based on the estimated value of the amount of substance in the vehicle cabin 26. The server controller 12 may calculate the evaluated value of the vehicle 20 based on the estimated value of the amount of substance in the vehicle cabin 26 that may be released into air. The server controller 12 may calculate the evaluated value of the vehicle 20 based on the estimated value of the amount of smell causing substance contained in air in the vehicle cabin 26 or the amount of smell causing substance that may be released into air. The greater the estimated value of the amount of smell causing substance contained in air in the vehicle cabin 26 or the amount of smell causing substance that may be released into air is, the lower the evaluated value of the vehicle 20 calculated by the server controller 12 may be. The greater an upper limit that the concentration of a smell causing substance in the vehicle cabin 26 may reach is, the lower the evaluated value of the vehicle 20 calculated by the server controller 12 may be.

After the procedure in step S32, the server controller 12 terminates the procedure as in the flowchart shown in FIG. 6 and returns to the procedure in step S4 in the flowchart shown in FIG. 3. The above-described procedure in each step in the flowchart shown in FIG. 6 may be appropriately omitted and may be performed in a different order.

Referring again to FIG. 3, the server controller 12 outputs information relating to the state of the vehicle 20 (step S4). The information relating to the state of the vehicle 20 may also be referred to as vehicle state information. As described above, the vehicle state information may include the maintenance information of the filter 34 of the vehicle 20 and may include the evaluated value of the vehicle 20.

The server controller 12 may output the vehicle state information to the vehicle 20. In a case where the maintenance information of the filter 34 is acquired as the vehicle state information, the control device 22 of the vehicle 20 may notify an occupant such as the driver of the vehicle 20, the owner of the vehicle 20, or the like of the maintenance information by means of the notification device 28. The occupant, the owner, or the like of the vehicle 20 may perform replacement or cleaning of the filter 34 based on the maintenance information. The occupant, the owner, or the like of the vehicle 20 may perform cleaning such as a deodorizing treatment or an antibacterial treatment on an interior furnishing in the vehicle cabin 26 based on the maintenance information.

In a case where the evaluated value of the vehicle 20 is acquired as the vehicle state information, the control device 22 of the vehicle 20 may notify an occupant such as the driver of the vehicle 20, the owner of the vehicle 20, or the like of the evaluated value of the vehicle 20 by means of the notification device 28. The occupant, the owner, or the like of the vehicle 20 may perform replacement or cleaning of the filter 34 or perform cleaning such as a deodorizing treatment or an antibacterial treatment on an interior furnishing in the vehicle cabin 26 based on the evaluated value of the vehicle 20. In a case where the evaluated value of the vehicle 20 is low, the occupant, the owner, or the like of the vehicle 20 may perform maintenance of the filter 34 or an interior furnishing in the vehicle cabin 26 to make the evaluated value higher.

The server controller 12 may output the vehicle state information to another terminal. The server controller 12 may output the vehicle state information to a terminal that manages maintenance of the vehicle 20, for example. The terminal that manages maintenance of the vehicle 20 may be installed in a repair shop such as a dealer. In the repair shop such as a dealer, maintenance of the filter 34 or an interior furnishing of the vehicle cabin 26 may be suggested to the owner of the vehicle 20 based on the vehicle state information. The server controller 12 may output the vehicle state information to a terminal that manages the appraisal price of the vehicle 20, for example. The terminal that manages the appraisal price of the vehicle 20 may be installed in a store such as a new car store and a used car store. The terminal that manages the appraisal price of the vehicle 20 may calculate a price at the time of trade-in or purchase of the vehicle 20 based on the vehicle state information. The store may present the trade-in price or purchase price of the vehicle 20 to the owner of the vehicle 20 based on the price calculated by the terminal.

After the procedure in step S4, the server controller 12 terminates the procedure as in the flowchart shown in FIG. 3. The above-described procedure in each step in the flowchart shown in FIG. 3 may be appropriately omitted and may be performed in a different order.

The procedures in the flowcharts shown in FIGS. 3, 4, 5, and 6 may be performed by the control device 22 of the vehicle 20. A procedure for sending information to the vehicle 20 or acquiring information from the vehicle 20 from among the procedures may be performed as internal processing in the vehicle 20.

As described above, the vehicle 20 or the information processing apparatus according to the present embodiment can provide information relating to a smell in the vehicle cabin 26 as information relating to the state of the vehicle 20 by performing each step shown as the information processing method. The information relating to the smell may include the maintenance information of the filter 34 and may include the evaluated value of the vehicle 20 based on the smell in the vehicle cabin 26. Since the vehicle 20 or the information processing apparatus provide the information relating to the smell, the occupant, the owner, or the like of the vehicle 20 is caused or motivated to perform maintenance of the vehicle 20. As a result, reduction of a smell in the vehicle cabin 26 may be promoted.

The embodiment of the disclosure has been described based on the drawings and examples. However, it should be noted that various changes or modifications can be easily made by those skilled in the art based on the disclosure. Accordingly, those changes or modifications should be construed as being included within the scope of the disclosure. For example, the functions or the like included in each means or each step can be rearranged without logical inconsistency, and a plurality of means or steps can be combined with each other or be divided.

What is claimed is:

1. A vehicle comprising:
a vehicle cabin;
a filter configured to allow air blown toward the vehicle cabin to pass through the filter while adsorbing at least a portion of a substance contained in the air;
a sensor configured to detect a state of the air passing through the filter; and
a control device configured to output information relating to maintenance of the filter based on a result of detection performed by the sensor.

2. The vehicle according to claim 1, wherein:
the sensor measures a concentration of a predetermined substance contained in the air passing through the filter; and
the control device outputs information promoting maintenance of the filter in a case where the concentration of the predetermined substance is equal to or greater than a concentration threshold value.

3. The vehicle according to claim 2, wherein the control device outputs the information promoting maintenance of the filter in a case where inside air circulation in the vehicle cabin continues for a time equal to or longer than a predetermined time and the concentration of the predetermined substance is equal to or greater than the concentration threshold value.

4. The vehicle according to claim 2, wherein:
the sensor further measures a temperature of the air passing through the filter; and
the control device sets the concentration threshold value based on the temperature.

5. The vehicle according to claim 2, wherein the predetermined substance includes gas which causes a person to sense a smell.

6. The vehicle according to claim 5, wherein the predetermined substance includes a fine particle adsorbing the gas.

7. An information processing apparatus comprising a controller communicably connected to a vehicle including a vehicle cabin,
wherein the controller outputs information relating to a state of the vehicle based on a result of detection about a state of air passing through a filter, the filter adsorbing at least a portion of a substance contained in air blown toward the vehicle cabin.

8. The information processing apparatus according to claim 7, wherein the controller outputs information relating to maintenance of the filter as the information relating to the state of the vehicle.

9. The information processing apparatus according to claim 8, wherein the controller outputs information promoting maintenance of the filter in a case where a concentration of a predetermined substance contained in the air passing through the filter is equal to or greater than a concentration threshold value.

10. The information processing apparatus according to claim 9, wherein the controller outputs the information promoting maintenance of the filter in a case where inside air circulation in the vehicle cabin continues for a time equal to or longer than a predetermined time and the concentration of the predetermined substance is equal to or greater than the concentration threshold value.

11. The information processing apparatus according to claim 9, wherein the controller sets the concentration threshold value based on a temperature of the air passing through the filter.

12. The information processing apparatus according to claim 9, wherein the predetermined substance includes gas which causes a person to sense a smell.

13. The information processing apparatus according to claim 12, wherein the predetermined substance includes a fine particle adsorbing the gas.

14. The information processing apparatus according to claim 7, wherein the controller outputs an evaluated value of the vehicle as the information relating to the state of the vehicle.

15. An information processing method comprising outputting information relating to a state of a vehicle based on a result of detection about a state of air passing through a filter by a controller communicably connected to the vehicle including a vehicle cabin, the filter adsorbing at least a portion of a substance contained in air blown toward the vehicle cabin.

16. The information processing method according to claim 15, further comprising outputting information relating to maintenance of the filter as the information relating to the state of the vehicle by the controller.

17. The information processing method according to claim 16, further comprising outputting information promoting maintenance of the filter by the controller in a case where a concentration of a predetermined substance contained in the air passing through the filter is equal to or greater than a concentration threshold value.

18. The information processing method according to claim 17, further comprising outputting the information promoting maintenance of the filter by the controller in a case where inside air circulation in the vehicle cabin continues for a time equal to or longer than a predetermined time and the concentration of the predetermined substance is equal to or greater than the concentration threshold value.

19. The information processing method according to claim 17, further comprising setting the concentration threshold value based on a temperature of the air passing through the filter by the controller.

20. The information processing method according to claim 15, further comprising outputting an evaluated value of the vehicle as the information relating to the state of the vehicle by the controller.
